(19) United States
(12) Patent Application Publication
(10) Pub. No.: US 2020/0279682 A1
(43) Pub. Date: Sep. 3, 2020

(54) MAGNETIC LEVITATION MOUNTED AND CONTROLLED PAYLOAD ON A CURVED SURFACE

(71) Applicant: Renjith THOMAS, Bangalore (IN)

(72) Inventor: Renjith THOMAS, Bangalore (IN)

(21) Appl. No.: 16/068,047

(22) PCT Filed: Jan. 3, 2017
(86) PCT No.: PCT/IN2017/050003

§ 371 Date: Jul. 3, 2018

(30) Foreign Application Priority Data
Jan. 4, 2016 (IN) 201641000232

(51) Int. Cl. H01F 7/02; H02J 50/00

(52) U.S. Cl. CPC H01F 7/0236; H02J 50/005

(57) ABSTRACT

Magnetic levitation mounted and controlled payload on a curved surface. Embodiments herein relate to magnetic levitation, and more particularly to levitating a payload using magnetic levitation. Embodiments herein disclose a payload mounted on a curved surface using magnetic levitation. Embodiments herein disclose a payload mounted on a curved surface using magnetic levitation, wherein the device can move over the surface using magnetic levitation.

### CROSS REFERENCE

The present application is a national stage filing under 35 U.S.C. § 371 of PCT application number PCT/IN2017/050003, having an international filing date of Jan. 3, 2017, which claims priority to Indian Patent Application Number 201641000232, having a filing date of Jan. 4, 2016, the disclosures of which are hereby incorporated by reference in their entireties.

### FIELD OF INVENTION

This invention relates to magnetic levitation, and more particularly to levitating a payload using magnetic levitation.

### BACKGROUND OF INVENTION

Currently, there are devices which require a 360 degree field of view, such as cameras (surveillance cameras, conferencing cameras, and so on), projectors, microphones, and so on, to provide a complete user experience. Consider a surveillance camera, which is mounted in a room. Even if the camera is placed on a swiveling mount with a 360 degree motion, the camera still has blind spots, such as right below the camera.

Current solutions use multiple devices to prevent dead zones (where the device does not have coverage, such as blind spots for a camera, an unlighted area for a projector, a zone from where the sound is not captured, and so on). However, these solutions are typically costly, as multiple devices are required. Also, the design and implementation of such solutions is complicated, as the systems have to be designed and placed appropriately to avoid dead zones. Back-end processing is also required to utilize the system efficiently. This can result in increase in equipment and power requirements.

### OBJECT OF INVENTION

The principal object of this invention is to provide a payload mounted on a curved surface using magnetic levitation.

Another object of the invention is to provide a payload mounted on a curved surface using magnetic levitation, wherein the device can move over the surface using magnetic levitation.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 depicts an apparatus comprising of a payload mounted on a spherical surface, according to embodiments as disclosed herein;

FIG. 2 depicts an example wherein a payload comprising of a camera and at least one microphone is mounted on a spherical surface, according to embodiments as disclosed herein;

FIGS. 3a and 3b depict examples of the movement of the payload across the spherical surface, according to embodiments as disclosed herein;

FIG. 4 depicts a cross-section of the apparatus, according to embodiments as disclosed herein;

FIGS. 5a and 5b depict location of the electromagnets in the apparatus, according to embodiments as disclosed herein;

FIGS. 5c and 5d depicts cross-sectional views of the apparatus, according to embodiments as disclosed herein;

FIG. 6 depicts the payload controller, according to embodiments as disclosed herein; and

FIG. 7 depicts the payload, according to embodiments as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

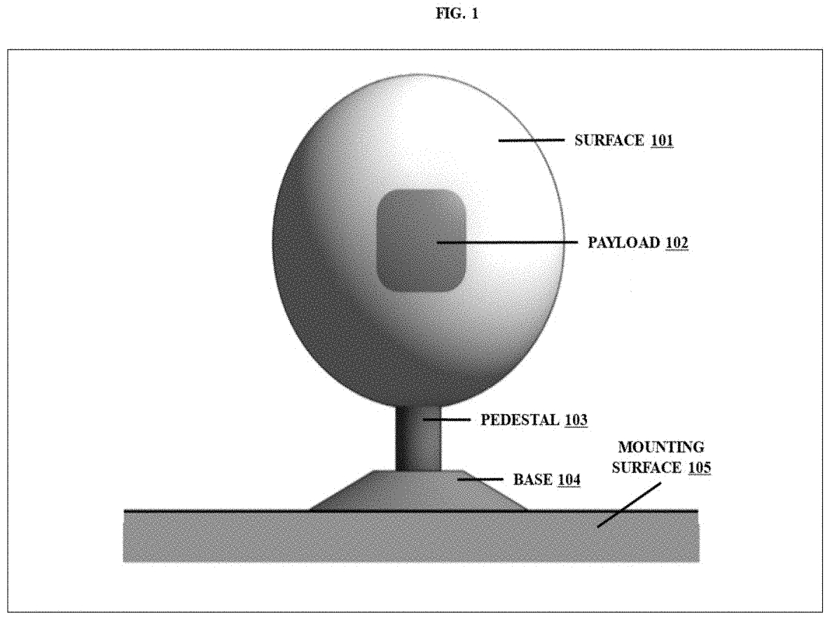

The embodiments herein provide a payload mounted on a curved surface using magnetic levitation, wherein the device can move over the surface using magnetic levitation. Referring now to the drawings, and more particularly to FIGS. 1 through 7, where similar reference characters denote corresponding features consistently throughout the figures, there are shown preferred embodiments.

Surface herein can refer to at least one a curved surface (for example, such as a spherical surface, hemispherical surface, and so on), wherein a payload can move over the surface using magnetic levitation. Payload herein can refer to an object which can move over the surface using magnetic levitation. The payload can comprise of a magnet and at least one other module. Examples of the module can be a camera (surveillance and/or video conference), a projector (a projector which can be used for presentations/displays, and so on, a projector which can be used for projecting light similar to a light show, and so on), a microphone, a speaker, a motion sensor, a radar, and so on. In another example, the payload can comprise of more than one other module.

FIG. 1 depicts an apparatus comprising of a payload mounted on a spherical surface. The payload 102 can be mounted on the surface 101 using magnetic levitation. The surface 101 can be mounted on a mounting surface 105 using a base 104 and a pedestal 103. The mounting surface 105 can be at least one of the ceiling, roof, floor, wall, door, window, and so on.

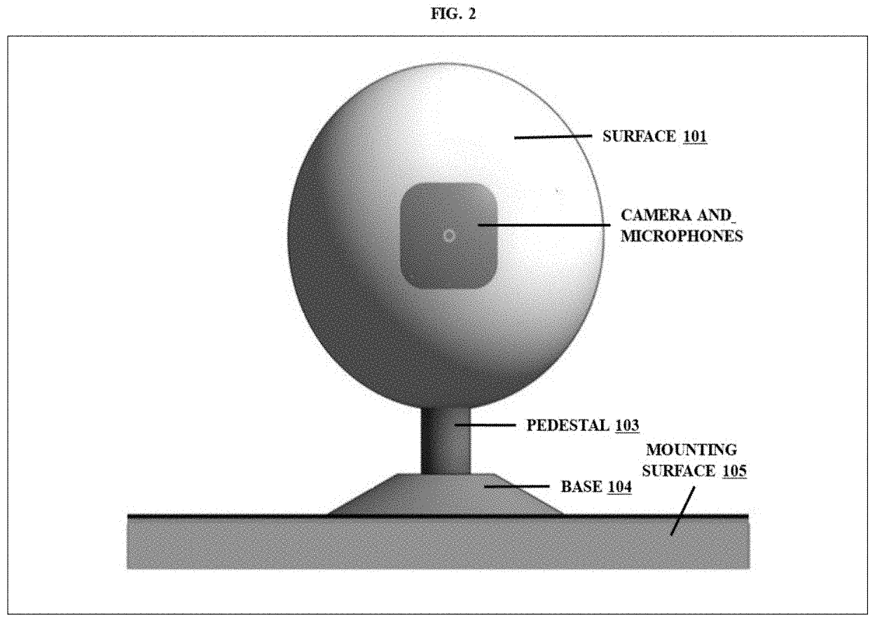

FIG. 2 depicts an example wherein a payload 102 comprising of a camera and at least one microphone is mounted on a spherical surface 101. The payload, in this example, is a camera and a plurality of microphones. The camera can automatically move, based on configured instructions. For example, if the camera is focused on a specific person and the person moves, the camera can move automatically to ensure that the person remains in the field-of-view of the camera. The camera can move, based on instructions provided by an authorized user.

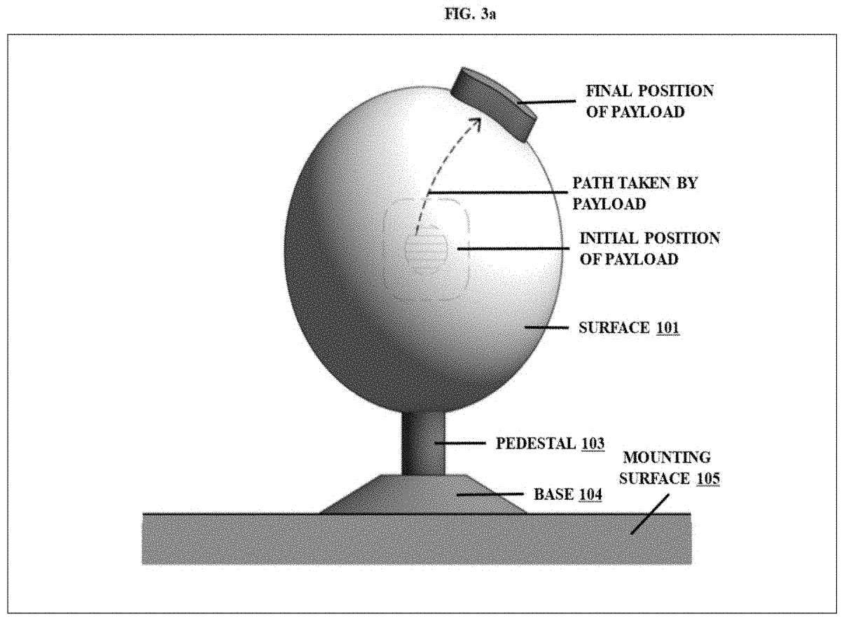

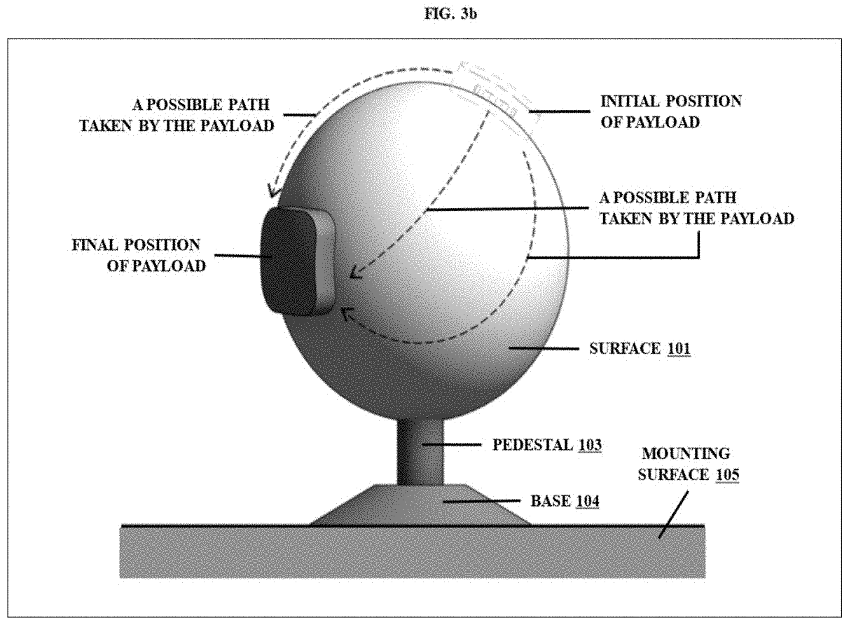

FIGS. 3a and 3b depict examples of the movement of the payload 102 across the spherical surface 101. In FIG. 3a, the payload 102 moves along a path from an initial position to a final position on the surface 101. In FIG. 3b, the payload 102 moves from an initial position to a final position; wherein the payload 102 has at least three possible paths to move from the initial position to the final position on the surface 101.

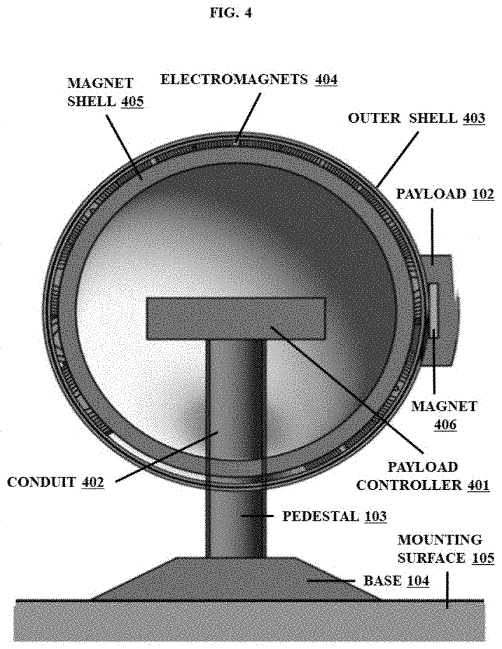

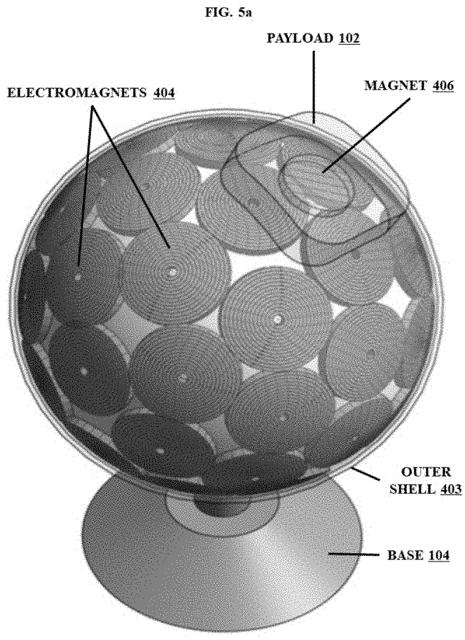

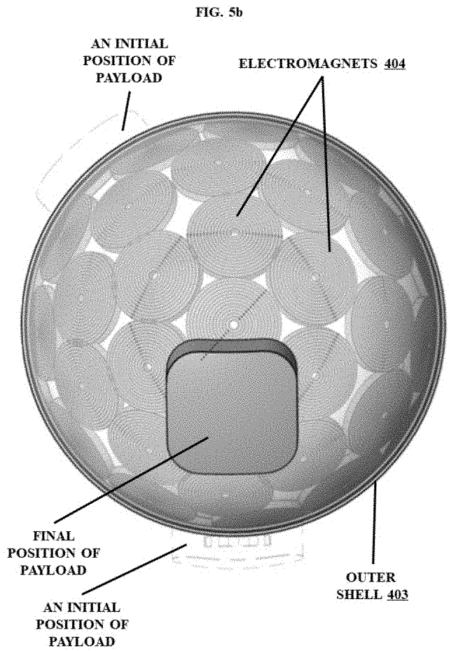

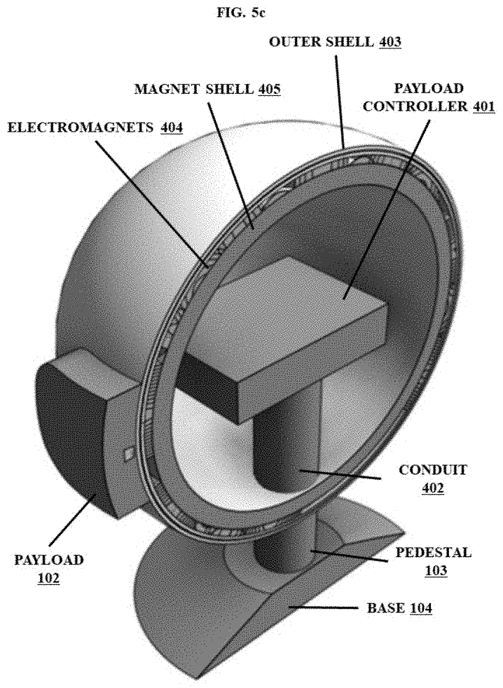

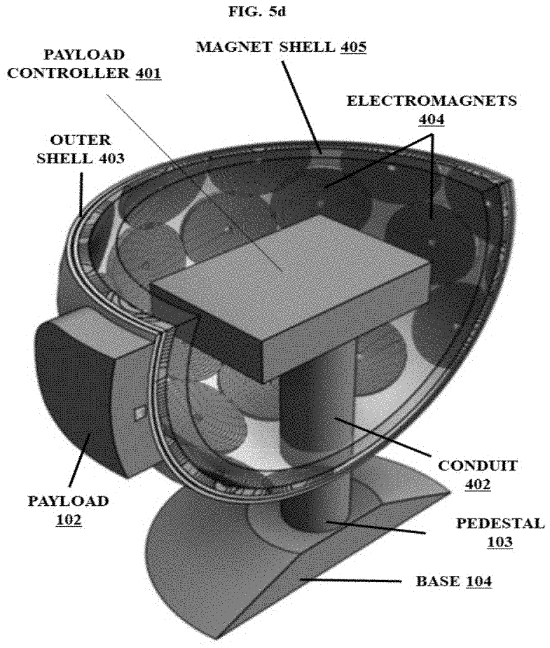

FIG. 4 depicts a cross-section of the apparatus. The apparatus, as depicted, comprises of an outer shell 403, on which the payload 102 is mounted. The outer shell 403 may be a smooth surface. In an embodiment, there can be an inner shell present, wherein the inner shell can be conductive. A plurality of electromagnets 404 can be mounted on a magnet shell 405, which serves as the base for mounting the electromagnets 404. FIGS. 5a and 5b depict the electromagnets located in the apparatus. In an embodiment herein, the electromagnets 404 can be a solenoid, and so on. The apparatus can be hollow in nature, wherein a payload controller 401 is present internal to the apparatus. A conduit 402 can be present, through which the payload controller 401 can communicate with at least one other external entity. The conduit 402 can be also used to provide a power supply to the payload controller 401. The payload controller 401 can control each of the electromagnets 404.

In an embodiment, the payload controller 401 can be present external to the apparatus, with the payload controller 401 communicating with the apparatus through the conduit 402.

FIGS. 5c and 5d depict the cross sectional view of the apparatus.

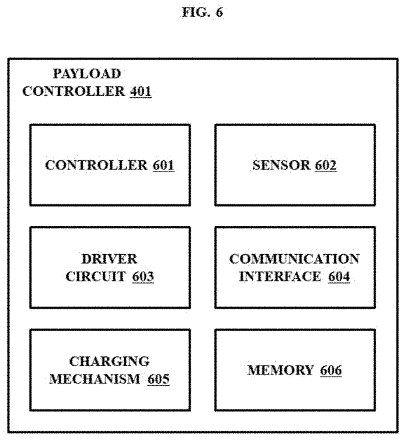

FIG. 6 depicts the payload controller. The payload controller 401 can comprise of a controller 601, at least one sensor 602, a driver circuit 603, at least one communication interface 604, a charging mechanism 605, and at least one memory 606. The communication interface 604 can comprise of at least one of a wireless communication interface and a wired communication interface. The communication interface 604 can enable the payload controller 401 to communicate with the payload 102, including providing instructions to the payload 102, receiving instructions from the payload 102, sending data to the payload 102 and receiving data from the payload 102. The communication interface 604 can enable the payload controller 401 to send and receive communication (comprising of instructions, data, and so on) from an external entity (such as a computing device, an authorized person, a system, and so on).

The memory 606 can comprise of a storage location for storing data. The memory 606 can comprise of at least one of an internal memory, an expandable memory, an external memory location, an external server, a file/data server, an online storage location, the Cloud, and so on.

The sensor 602 can enable the controller 601 to determine the current location of the payload 102 on the surface 101. The sensor 602 can comprise of at least one of a magnetic sensor, proximity sensors, 3-dimensional proximity sensors, radars, and so on. In an example, wherein the sensor 602 is a magnetic sensor, which in turn comprises of a magnetometer. In an embodiment, the magnetometer can comprise a 3-axis magnetometer, wherein the 3-axis magnetometer can be used to determine the co-ordinates of the payload 102 on the surface 101. In an example herein, the sensor 602 can comprise of at least one magnetic field sensor. The sensor 602 can be configured to measure the strength and direction of the magnetic field. In an embodiment herein, the sensor 602 can be configured to measure the strength and direction of the magnetic field at a plurality of points within the surface 101.

The driver circuit 603 can be connected to each of the electromagnets 404. The driver circuit 603 can control the ON/OFF, magnetic field strength of each of the electromagnets 404, the polarity of each of the electromagnets 404, and so on; based on instructions received from the controller 601.

The charging mechanism 605 can comprise of a means for wireless charging of the payload 102. The charging mechanism 605 can use a suitable means such as inductive charging, conductive charging, power beaming, or any other equivalent means. The charging mechanism 605 can be controlled by the controller 601, and can charge the payload 102 as required (on receiving instructions from the controller 601, on the controller 601 receiving an intimation from the payload 102 that the battery capacity of the payload 102 has gone below a pre-defined threshold). The charging mechanism 605 can charge the payload in a continuous manner.

The controller 601 can monitor the location of the payload 102 on the surface 101. The controller 601 can maintain the magnetic field strength, so as to hold the payload 102 in location, by controlling the electromagnets 404 through the drive controller 603. The controller 601 can receive a request from the payload 102 that the payload 102 wants to move to a new location. The payload 102 can automatically determine that the payload 102 has to move, based on at least one pre-defined condition. For example, consider that the payload comprises of a camera, the camera is tracking an object in its field of view. On detecting that the object has moved, the camera has to move to a new location to maintain the object in its field of view. In another example, consider that the payload comprises of a motion sensing camera, and the camera senses motion beyond its field of vision, the camera can move to a new location, depending on the identified movement, so as to bring the object that caused the movement into its field of vision. In another example, consider that the payload comprises of a microphone which is being used to capture speech from a user. On detecting that the user has moved resulting in less than optimal capture of the speech, the payload can move to a determined location to enable speech to be captured more easily. The controller 601 can also receive communication from an external entity to move the payload 102 to a specific location.

On determining that the payload 102 has to move from the current position on the surface 101 (first position) to a new position on the surface 101 (second position), the controller 601 can determine at least one optimal path along which the payload 102 can move from the first position to the second position. The controller 601 can determine the optimal path based on factors such as energy efficiency, the shortest path, the quickest path, and so on. The controller 601 can also determine other factors related to the motion of the payload 102 from the first position to the second position, such as velocity, and so on.

On determining the optimal path and the velocity, the controller 601 can modulate the magnetic fields produced by the electromagnets 404 to enable the payload 102 to move from the first position to the second position along the determined optimal path (as depicted in FIGS. 3a and 3b). On the payload 102 reaching the second position, the controller 601 can maintain the energized state of the electromagnets 404, so as to maintain the payload 102 in that second position.

In an embodiment herein, the controller 601 can maintain the payload 102 in a pattern of continuous steady motion across the surface 101. The pattern and speed of motion can be determined by the controller 601 automatically, based on at least one criteria. The pattern and speed of motion can be provided to the controller 601 by an external entity.

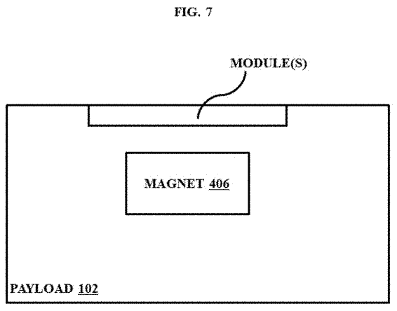

FIG. 7 depicts the payload. The payload 102 can comprise of a magnet 701, and at least one module. In an embodiment herein, the magnet 406 can be a permanent magnet, an electromagnet and so on. In an embodiment herein, the magnet 406 can be an electromagnet. The payload 102 can comprise of at least one module. Examples of the modules can be at least one camera, at least one microphone, at least one projector, at least one speaker, at least one radar, and so on.

In an embodiment herein, the payload 102 can comprise of a communication interface which can enable the modules present in the payload to communicate with the payload controller 401 or an external entity, using a wireless communication means.

In an embodiment herein, the payload 102 can comprise of at least one orientation sensor, which can monitor the orientation of the payload 102 on the surface 101, and use the communication interface of the payload 102 to communicate to the payload controller 401. The controller 601 can control the orientation of the payload 102 to ensure that the payload 102 is oriented in a correct manner.

In an embodiment herein, the payload 102 can comprise of a battery. The battery can be charged in a wireless manner. In an embodiment herein, the battery can be a battery of a small form factor, such as a coin battery, and so on.

In an embodiment herein, the payload 102 can comprise of a memory. The memory can comprise of a storage location for storing data. The memory can comprise of at least one of an internal memory, an expandable memory, an external memory location, an external server, a file/data server, an online storage location, the Cloud, and so on.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. An apparatus comprising of a payload configured to move over a surface using magnetic levitation, wherein the surface is a curved surface.

2. The apparatus, as claimed in claim 1, wherein the surface encloses a plurality of electromagnets.

3. The apparatus, as claimed in claim 2, wherein magnetic fields produced by the electromagnets are modulated to enable the payload to move from a first location on the surface to a second location on the surface.

4. The apparatus, as claimed in claim 3, wherein the payload is configured to move from the first location to the second location in at least one of an automatic manner based on at least one pre-defined criteria; and
receiving an instruction from an external entity.

5. The apparatus, as claimed in claim 1, wherein the apparatus is configured to provide power to the payload wirelessly.

6. The apparatus, as claimed in claim 1, wherein the apparatus comprises of at least one sensor, wherein the at least one sensor can determine current location of the payload on the surface.
